(19) United States
(12) Patent Application Publication
(10) Pub. No.: US 2007/0064877 A1
(43) Pub. Date: Mar. 22, 2007

(54) Collimator for adjusting X-ray beam

(75) Inventors: Yinong Liu, Beijing (CN); Zhiqiang Chen, Beijing (CN); Yuanjing Li, Beijing (CN); Wanlong Wu, Beijing (CN); Yulan Li, Beijing (CN); Xilei Luo, Beijing (CN); Li Zhang, Beijing (CN); Ziran Zhao, Beijing (CN); Bin Sang, Beijing (CN); Hailin Wang, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignees: Nuctech Company Limited, Beijing (CN); Tsinghua University, Beijing (CN)

(21) Appl. No.: 11/525,692

(22) Filed: Sep. 22, 2006

(30) Foreign Application Priority Data
Sep. 22, 2005 (CN) 200510086456.5

(51) Int. Cl. G21K 1/04

(52) U.S. Cl. 378/150

(57) ABSTRACT

Disclosed is a collimator for adjusting X-ray beam, comprising: an up-and-down adjustment mechanism (11); a left-and-right adjustment mechanism (21); a supporting member (15); and an adjusting plate (17) connected with the supporting member (15), wherein: said up-and-down adjustment mechanism (11) comprises a first rotating nut (13), an up-and-down moving leading screw (12) threadedly connected with said first rotating nut (13), and upper and lower sliding stops (18) located in said supporting member (15), wherein ends of said leading screw (12) are connected with said upper and lower sliding stops (18) to drive said upper and lower sliding stops (18), respectively, to vertically move; and said left-and-right adjustment mechanism (21) comprises a second rotating nut (23), a horizontally moving leading screw (22) connected with said second rotating nut (23), and left and right sliding stops (25) located in said supporting member (15), wherein inner ends of said horizontally moving leading screw (22) are connected with said left and right sliding stops (25) to drive said left and right sliding stops (25), respectively, to horizontally move. With the above arrangement, symmetrical adjustments along an up-and-down direction and along a left-and-right direction can be obtained. With rotation of the rotating nuts, respective leading screws move linearly rather than rotate, so that X-ray beams with different field angles can be obtained.

### FIELD OF THE INVENTION

The present invention relates to the radiation detecting technical field, and more particularly, to a collimator for adjusting X-ray beam.

### DESCRIPTION OF THE RELATED ART

In some radiation detecting systems, such as CT imaging systems, X-ray tubes are used to generate X-ray. The X-ray is usually emitted in a conical shape from a focal spot. Since application modes of X-ray are diversified, it is required to employ a collimator to define profiles of X-ray. In the conventional techniques, a linear collimator, a rectangular collimator, or combination thereof is employed to define profiles of X-ray.

The conventional collimator has a large volume and a complicated structure, in which an upper sliding stop and a lower sliding stop can only be opened or closed simultaneously when adjustment is performed, and a left stop and a right stop are usually stationary and are not adjustable. If target points of an X-ray generator are not symmetrically formed between the upper and lower sliding stops, it is required to adjust the position of one of the upper and lower sliding stops and the target points of the X-ray generator, in order to ensure an effective adjustment of the upper and lower sliding stops. Thus, the conventional collimator is disadvantageous in that a larger space is occupied and the adjustment precision is low.

### SUMMARY OF THE INVENTION

Accordingly, in order to overcome the defects in the prior art, an object of this invention is to provide a collimator for adjusting X-ray beam. The collimator can symmetrically perform adjustments along an up-and-down direction and along a left-and-right direction around target points of a fixed X-ray generator, so that X-ray beams with different field angles can be obtained.

An object of the invention is to provide an adjustment device for adjusting a collimator that can separately adjust respective sliding stops of the collimator.

In order to achieve the above object of the invention, one aspect of this invention provides a collimator for adjusting X-ray beam, comprising:

an up-and-down adjustment mechanism; a left-and-right adjustment mechanism; a supporting member; and an adjusting plate connected with the supporting member, wherein:

the up-and-down adjustment mechanism comprises a first rotating nut, an up-and-down moving leading screw threadedly connected with the first rotating nut, and upper and lower sliding stops located in the supporting member, wherein ends of the leading screw are connected with the upper and lower sliding stops to drive the upper and lower sliding stops, respectively, to vertically move; and

the left-and-right adjustment mechanism comprises a second rotating nut, a horizontally moving leading screw connected with the second rotating nut, and left and right sliding stops located in the supporting member, wherein inner ends of the horizontally moving leading screw are connected with the left and right sliding stops to drive the left and right sliding stops, respectively, to horizontally move.

With the above arrangement, symmetrical adjustments along an up-and-down direction and along a left-and-right direction can be obtained. With rotating nuts, the leading screws move linearly rather than rotate, so that X-ray beams with different field angles can be obtained.

Preferably, the up-and-down adjustment mechanism further comprises a first limiting gland cover. The first limiting gland cover is fixed to upper and lower wall surfaces of the supporting member and confines the first rotating nut to rotate within the first limiting gland cover.

Preferably, the left-and-right adjustment mechanism further comprises a second limiting gland cover. The second limiting gland cover is fixed to left and right wall surfaces of the supporting member and confines the second rotating nut to rotate within the second limiting gland cover.

Preferably, the up-and-down moving leading screw is provided at ends thereof with opening grooves. The opening grooves are connected with the upper and lower sliding stops provided in a longitudinal sliding slot of the supporting member.

Preferably, the horizontally moving leading screw is provided at ends thereof with abutting surfaces. The abutting surfaces are connected with left and right sliding stops provided in the supporting member.

Preferably, the first rotating nut and the second rotating nut are marked with scales and numerals.

Preferably, the up-and-down moving leading screw and the horizontally moving leading screw are marked at ends thereof with scales and numerals corresponding to the first rotating nut and the second rotating nut.

Preferably, a fixed stop is provided behind the upper and lower sliding stops in the supporting member.

Preferably, the upper and lower sliding stops and the left and right sliding stops are made of tungsten alloy or lead alloy.

In order to achieve the above objects of the invention, another aspect of this invention provides an adjustment device for adjusting collimator, comprising:

an up-and-down adjustment mechanism; a left-and-right adjustment mechanism; and a supporting member; wherein:

the up-and-down adjustment mechanism comprises a first rotating nut, an up-and-down moving leading screw threadedly connected with the first rotating nut, and upper and lower sliding stops located in the supporting member, wherein ends of the leading screw are connected with the upper and lower sliding stops to drive the upper and lower sliding stops, respectively, to vertically move; and

the left-and-right adjustment mechanism comprises a second rotating nut, a horizontally moving leading screw connected with the rotating nut, and left and right sliding stops located in the supporting member, wherein inner ends of the horizontally moving leading screws are connected with the left and right sliding stops to drive the left and right sliding stops, respectively, to horizontally move.

With the above technical schemes, the following benefits are achieved:
1) The value of field angle of ray beam can be effectively controlled;
2) The width of ray beam can be optionally adjusted;
3) Each adjustment unit on the collimator can be separately adjusted, so that the collimator can be applied to various radiation imaging systems.

### BRIEF DESCRIPTION OF THE DRAWINGS

FIG. 1 shows a structural schematic view of this invention;

FIG. 2 shows a top view of FIG. 1;

FIG. 3 shows a cross-sectional view taken along line A-A of FIG. 1;

FIG. 4 shows a perspective view of a T-type leading screw of this invention.

### DETAILED DESCRIPTION OF THE PREFERRED EMBODIMENT

A preferred embodiment of the present invention will be described herein below with reference to the accompanying drawings. It is to be understood that the following preferred embodiment is only illustrative and will not intend to limit the protection scope of the present invention.

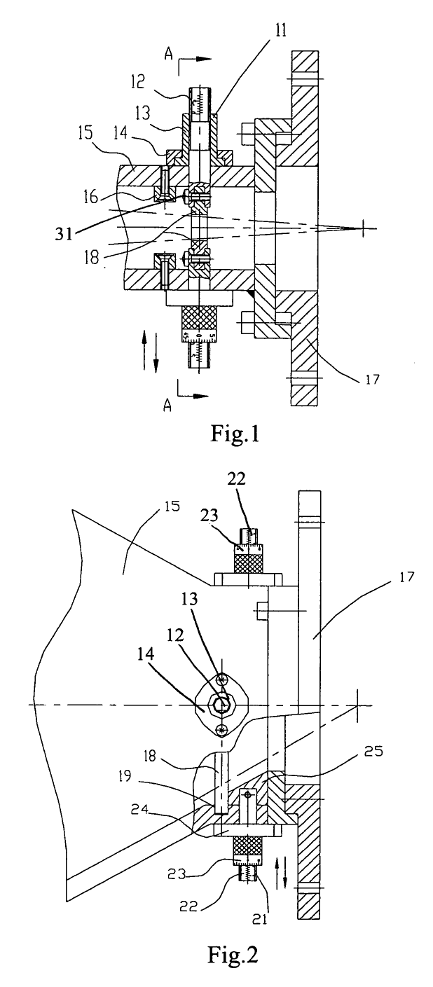

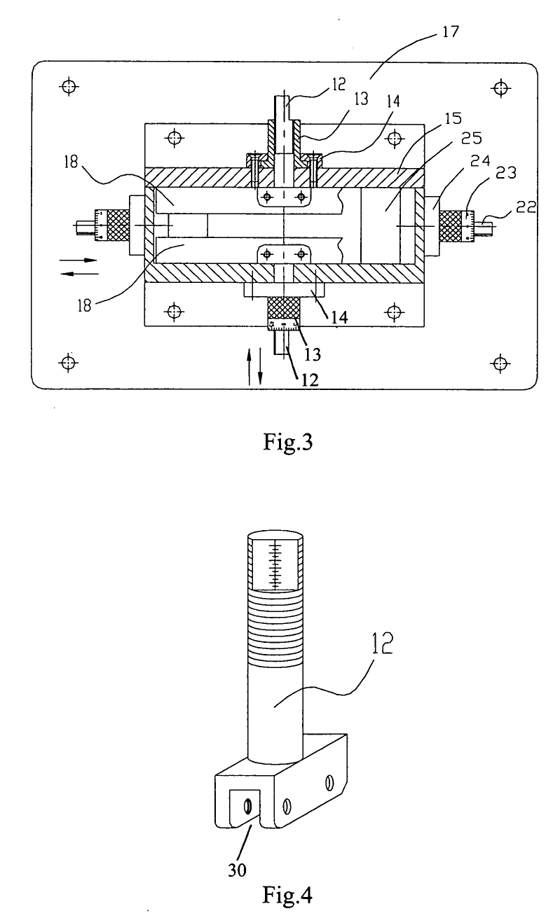

Referring to FIGS. 1-4, the collimator according to this invention comprises an up-and-down adjustment mechanism 11, a left-and-right adjustment mechanism 21, a supporting member 15 and an adjusting plate 17 connected with the supporting member 15. Upper and lower sliding stops 18 and left and right sliding stops 25 are made of tungsten alloy or lead alloy. In the preferred embodiment, the up-and-down adjustment mechanism 11 comprises a first limiting gland cover 14, a first rotating nut 13, a leading screw threadedly connected with the first rotating nut 13, such as a T-type leading screw 12 as shown in FIG. 4, and the upper and lower sliding stops 18. The first limiting gland cover 14 is fixed to an upper wall surface and a lower wall surface of the supporting member 15, and confines the first rotating nut 13 to rotate within the first limiting gland cover 14.

A certain gap is formed between the first rotating nut 13 and the first limiting gland cover 14 so as to form a clearance fit therebetween. Clearance fit also can be formed at a position where the T-type leading screw 12 goes through the supporting member 15.

The T-type leading screw 12 is provided on ends thereof with opening grooves. The upper and lower sliding stops 18 provided in a longitudinal sliding slot 19 of the supporting member 15 are inserted into the opening grooves 30 of the T-type leading screw 12 vertically moved up and down, and are fixed by screws 31. With rotation of the first rotating nut 13, the T-type leading screw 12 is driven to longitudinally and linearly move, so that a slit formed between the upper and lower sliding stops 18 can be adjusted.

A fixed stop 16 provided behind the upper and lower sliding gland cover 18 is used to shield slits exposed from upper and lower ends when the upper and lower sliding stops 18 are adjusted to be closed.

The left-and-right adjustment mechanism 21 comprises a second limiting gland cover 24, a second rotating nut 23, a horizontally and left-and-right moving leading screw 22 threadedly connected with the second rotating nut 23, and left and right sliding stops 25. The second limiting gland cover 24 is fixed to a left wall surface and a right wall surface of the supporting member 15, and confines the second rotating nut 23 to rotate within the second limiting gland cover 24. The horizontally moving leading screw 22 linearly moves by the second rotating nut 23.

The horizontally moving leading screw 22 is provided in the inner ends thereof with abutting surfaces. The abutting surfaces are connected with the left and right sliding stops 25 provided in the supporting member 15. The horizontally moving leading screw 22 brings the left and right sliding stops to move along a left-to-right direction (a horizontal direction).

Furthermore, in order to observe the adjustment amount of the upper and lower sliding stops 18 and the left and right sliding stops 25, scales and numerals are marked on the first rotating nut 13 and the second rotating nut 23. Scales and numerals readable and corresponding to the first rotating nut 13 and the second rotating nut 23 are marked on the ends of the T-type leading screw 12 and the horizontally moving leading screw 22.

While the invention has been shown and described with reference to the preferred embodiment thereof, it will be understood by those skilled in the art that various changes in form and details may be made therein without departing from the spirit and scope of the invention as defined by the appended claims.

1. A collimator for adjusting X-ray beam, comprising:
an up-and-down adjustment mechanism (11);
a left-and-right adjustment mechanism (21);
a supporting member (15); and
an adjusting plate (17) connected with the supporting member (15), wherein:
said up-and-down adjustment mechanism (11) comprises a first rotating nut (13), an up-and-down moving leading screw (12) threadedly connected with said first rotating nut (13), and upper and lower sliding stops (18) located in said supporting member (15), wherein ends of said leading screw (12) are connected with said upper and lower sliding stops (18) to drive said upper and lower sliding stops (18), respectively, to vertically move; and
said left-and-right adjustment mechanism (21) comprises a second rotating nut (23), a horizontally moving leading screw (22) connected with said second rotating nut (23), and left and right sliding stops (25) located in said supporting member (15), wherein inner ends of said horizontally moving leading screw (22) are connected with said left and right sliding stops (25) to drive said left and right sliding stops (25), respectively, to horizontally move.

2. The collimator for adjusting X-ray beam according to claim 1, characterized in that:
said up-and-down adjustment mechanism (11) further comprises a first limiting gland cover (14), and said first limiting gland cover is fixed to upper and lower wall surfaces of said supporting member (15) and confines said first rotating nut (13) to rotate within said first limiting gland cover (14).

3. The collimator for adjusting X-ray beam according to claim 1, characterized in that:
said left-and-right adjustment mechanism (21) further comprises a second limiting gland cover (24), and said second limiting gland cover is fixed to left and right wall surfaces of said supporting member (15) and confines said second rotating nut (23) to rotate within said second limiting gland cover (24).

4. The collimator for adjusting X-ray beam according to claim 1, characterized in that:
said up-and-down moving leading screw (12) is provided at ends thereof with opening grooves, and said opening grooves are connected with said upper and lower sliding stops (18) provided in a longitudinal sliding slot (19) of said supporting member (15).

5. The collimator for adjusting X-ray beam according to claim 1, characterized in that:
said horizontally moving leading screw (22) is provided at ends thereof with abutting surfaces, and said abutting surfaces are connected with left and right sliding stops (25) provided in said supporting member (15).

6. The collimator for adjusting X-ray beam according to claim 1, characterized in that:
said first rotating nut (13) and said second rotating nut (23) are marked with scales and numerals.

7. The collimator for adjusting X-ray beam according to claim 7, characterized in that:
said up-and-down moving leading screw (12) and said horizontally moving leading screw (22) are marked at ends thereof with scales and numerals corresponding to said first rotating nut (13) and said second rotating nut (23).

8. The collimator for adjusting X-ray beam according to claim 1, characterized in that:
a fixed stop (16) is provided behind the upper and lower sliding stops (18) in said supporting member (15).

9. The collimator for adjusting X-ray beam according to claim 1, characterized in that:
said upper and lower sliding stops (18) and said left and right sliding stops (25) are made of tungsten alloy or lead alloy.

10. An adjustment device for adjusting collimator, comprising:
an up-and-down adjustment mechanism (11);
a left-and-right adjustment mechanism (21); and
a supporting member (15); wherein:
said up-and-down adjustment mechanism (11) comprises a first rotating nut (13), an up-and-down moving leading screw (12) threadedly connected with said first rotating nut (13), and upper and lower sliding stops (18) located in said supporting member (15), wherein ends of said leading screw (12) are connected with said upper and lower sliding stops (18) to drive said upper and lower sliding stops (18), respectively, to vertically move; and
said left-and-right adjustment mechanism (21) comprises a second rotating nut (23), a horizontally moving leading screw (22) connected with said rotating nut (23), and left and right sliding stops (25) located in said supporting member (15), wherein inner ends of said horizontally moving leading screws (22) are connected with said left and right sliding stops (25) to drive said left and right sliding stops (250, respectively, to horizontally move.

11. The adjustment device for adjusting a collimator according to claim 10, characterized in that:
said up-and-down adjustment (11) further comprises a first limiting gland cover (14), and said first limiting gland cover is fixed to upper and lower wall surfaces of said supporting member (15) and confines said first rotating nut (13) to rotate within said first limiting gland cover (14).

12. The adjustment device for adjusting a collimator according to claim 10, characterized in that:
said left-and-right adjustment mechanism (21) further comprises a second limiting gland cover (24), and said second limiting gland cover is fixed to left and right wall surfaces of said supporting member (15) and confines said second rotating nut (23) to rotate within said second limiting gland cover (24).

13. The adjustment device for adjusting a collimator according to claim 10, characterized in that:
said up-and-down moving leading screw (12) is provided at ends thereof with opening grooves, and said opening grooves are connected with said upper and lower sliding stops (18) provided in a longitudinal sliding slot (19) of said supporting member (15).

14. The adjustment device for adjusting a collimator according to claim 10, characterized in that:
said horizontally moving leading screw (22) is provided at ends thereof with abutting surfaces, and said abutting surfaces are connected with left and right sliding stops (25) provided in said supporting member (15).

15. The adjustment device for adjusting a collimator according to claim 10, characterized in that:
said first rotating nut (13) and second rotating nut (23) are marked with scales and numerals.

16. The adjustment device for adjusting a collimator according to claim 15, characterized in that:
said up-and-down moving leading screw (12) and said horizontally moving leading screw (22) are marked at ends thereof with scales and numerals corresponding to said first rotating nut (13) and said second rotating nut (23).

17. The adjustment device for adjusting a collimator according claim 10, characterized in that:
a fixed stop (16) is provided behind the upper and lower sliding stops (18) in said supporting member (15).

18. The adjustment device for adjusting a collimator according claim 10, characterized in that:
said upper and lower sliding stops (18) and said left and right sliding stops (25) are made of tungsten allow or lead alloy.
